(19) United States
(12) Patent Application Publication
(10) Pub. No.: US 2017/0187212 A1
(43) Pub. Date: Jun. 29, 2017

(54) CHARGING SYSTEM WITH SWAPPABLE BATTERY BANKS

(71) Applicant: Incipio, LLC, Irvine, CA (US)

(72) Inventor: Timothy Hemesath, Clovis, CA (US)

(21) Appl. No.: 15/348,866

(22) Filed: Nov. 10, 2016

Related U.S. Application Data
(60) Provisional application No. 62/272,445, filed on Dec. 29, 2015.

(51) Int. Cl. H02J 7/00

(52) U.S. Cl. CPC H02J 7/0044; H02J 7/0021

(57) ABSTRACT

A portable charging system having a charging dock and one or more battery banks is disclosed. The charging dock has at least one charging cavity each of which is configured to have two charging pins that can be plugged into charging contacts on the bottom side of one of the one or more battery banks to supply power to the battery bank when secured in the charging position while providing further stability to the battery bank when it is secured in charging cavity.

### INCORPORATION BY REFERENCE TO RELATED APPLICATIONS

This application claims benefit under 35 U.S.C. §119(e) from U.S. Provisional Application No. 62/272,445, filed on Dec. 29, 2015, which is hereby incorporated by reference in its entirety.

### BACKGROUND

Field of the Invention

This patent document relates to portable charging system with swappable battery banks for charging portable or mobile consumer electronic devices such as cellular or smart phones, computing tablets, MP3 players, gaming devices, laptop computers, portable charging devices therefore, and the like. In particular such portable charging system include a charging dock and portable rechargeable battery banks.

Description of the Related Art

Docking station and portable rechargeable battery banks are known in the art. It is desirable that the charging dock is as thin as possible to make it portable or ease to carry around. However, when the charging dock is thin, a charging cavity built on the dock may not have enough supporting depth to secure the battery banks that are under charging. Therefore, the battery bank is unstable while charging and the charging process may be interrupted. The inventor here recognized that there is a continuing need to improve the configuration of conventional docking station and battery banks to enhance user experience.

### SUMMARY

Various aspects described in connection with the embodiments of the inductive battery bank disclosed herein, including the drawings and claims, may be combined to form claims for a device, apparatus, system, methods of manufacture and/or use in any way without limitation.

### BRIEF DESCRIPTION OF THE DRAWINGS

FIG. 1 illustrates a representative portable charging system with one battery bank plugged into the charging dock and the other connected to a mobile device.

FIG. 2 is a perspective view of a battery bank.

FIG. 3 is a perspective view of a charging dock with a battery bank inserted.

FIG. 4 is another perspective view of the charging dock and battery bank of FIG. 3.

FIGS. 5A-5F are front, rear, left, right, top and bottom views of the charging dock and battery bank of FIGS. 3 and 4.

FIG. 6 is a perspective view of the battery bank of FIG. 2 with the charging cable wrapped in a closed position.

FIGS. 7A-7F are front, rear, left, right, top and bottom views of the battery bank of FIG. 6.

### DETAILED DESCRIPTION

Features, aspects and advantages are described below with reference to the drawings, which are intended to illustrate but not to limit the invention. In the drawings, like reference characters denote corresponding features consistently throughout similar embodiments.

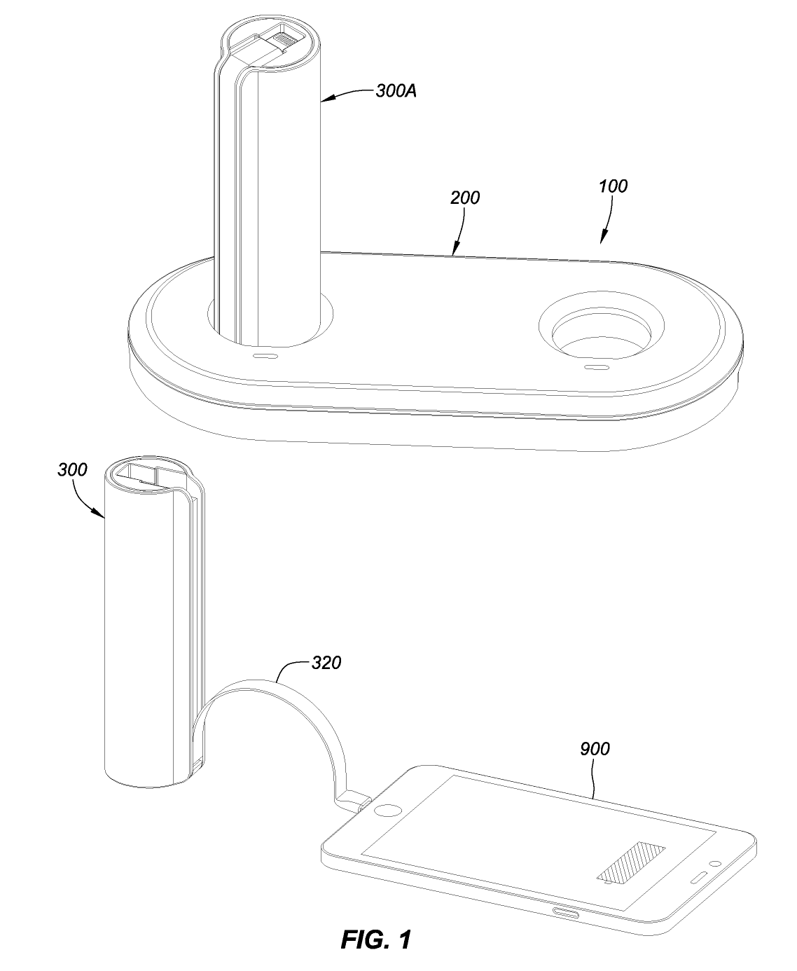

FIG. 1 illustrates a representative portable charging system 100 with one battery bank 300A docked into a charging cavity of charging dock 200 while another battery bank 300 is connected with a mobile device 900 through a cable 320 to supply power to the mobile device 900. Each of the battery banks 300, 300A can be independently docked into any one of the charging cavities of the charging dock 200 to receive power. When both battery banks 300, 300A are docked into the charging dock 200, both battery banks 300, 300A can be charged simultaneously. It is understood that the charging system 100 may include more than two battery banks. It is also understood that the charging system 100 may include only one battery bank.

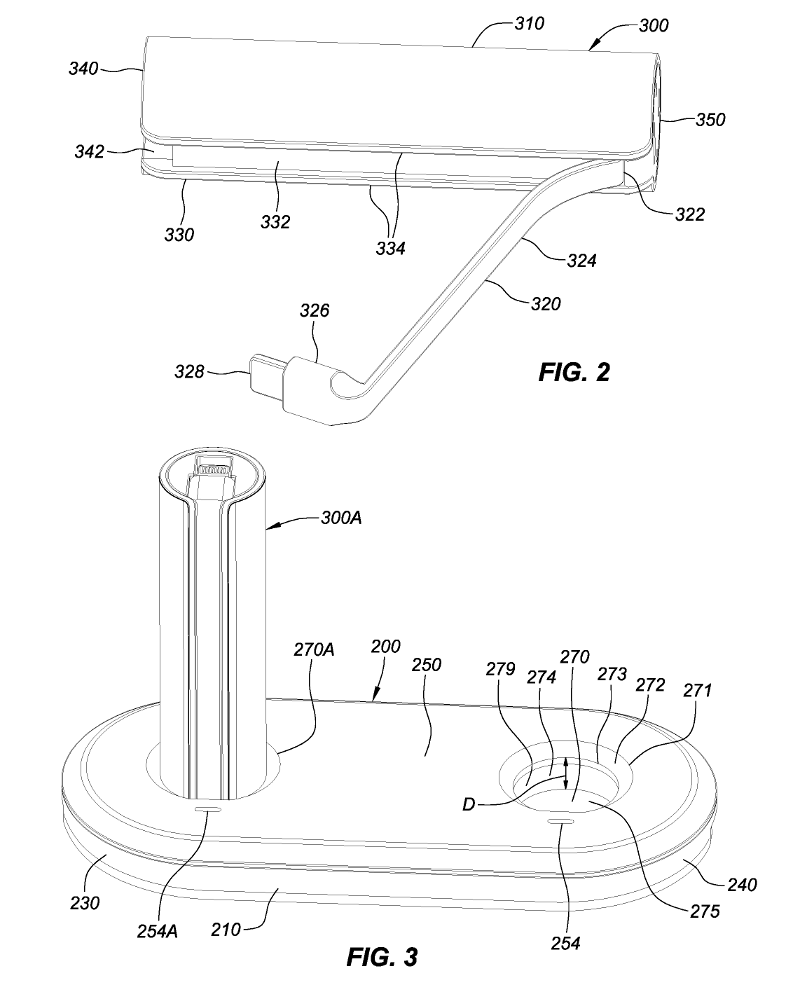

FIG. 2 is a perspective view of a battery bank 300. The battery bank 300 has a generally cylindrical housing 310 that include therein one or more rechargeable batteries (not shown). The battery bank may be provided with a removable cap to allow rechargeable batteries to be removed or placed by the user, or the battery bank may be permanently sealed to preclude the removal or replacement of the rechargeable batteries.

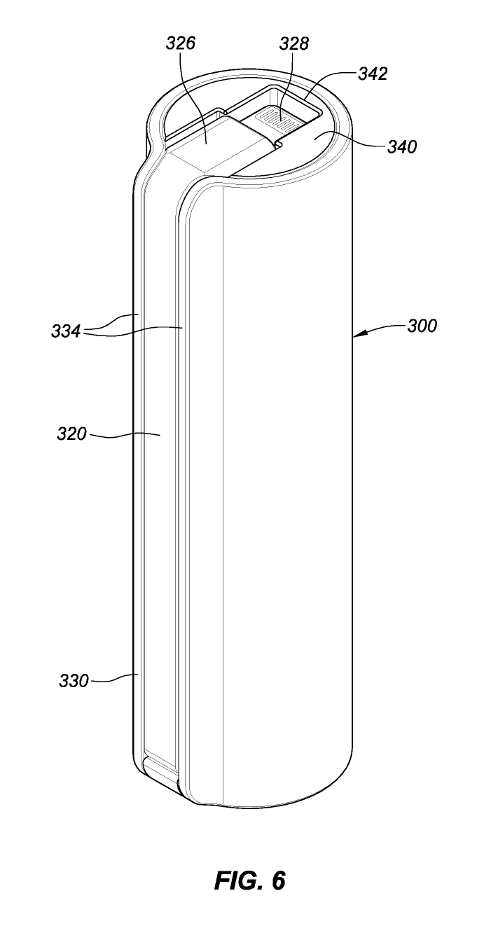

The battery bank 300 has a front facing side 330, a top side 340 and a bottom side 350. The battery bank 300 includes a built-in cable 320 that can be concealed within groove formed into the side of the housing 310 in a storage mode when the cable 320 is fully wrapped in a first direction (as shown in FIG. 6). The charging connector of the cable is tucked into a retention or storage cavity 342 that is formed on the top side 340 of the housing 310. When the cable 320 is partially unwrapped, (as shown in FIG. 2), the flexible cable may connected to an electronic device.

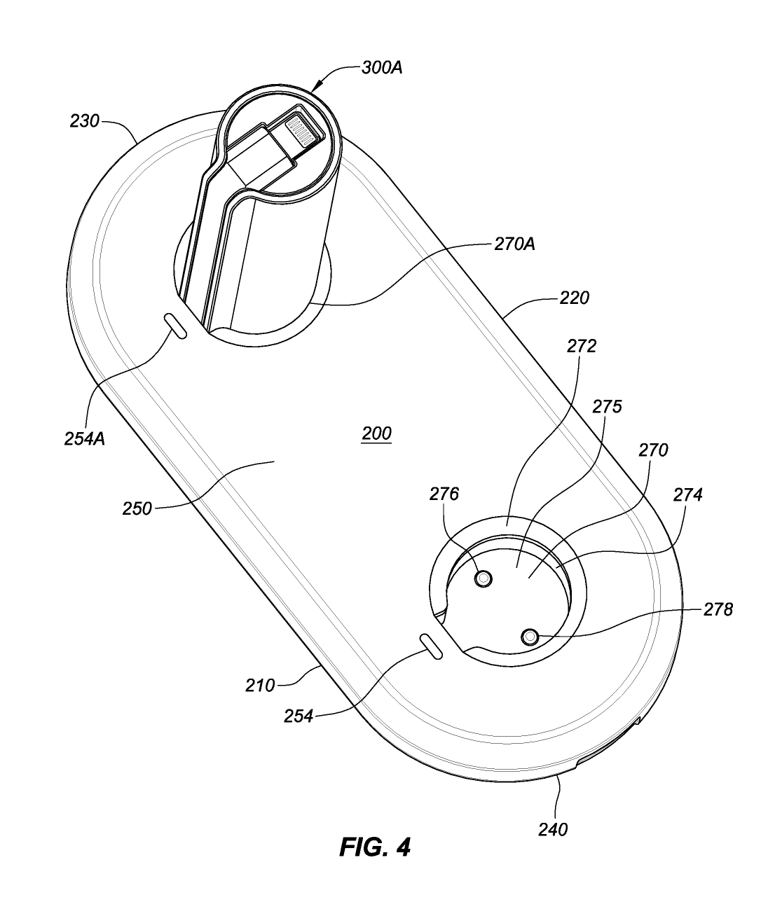

FIGS. 3-4 are perspective views of a charging dock 200 with a battery bank 300A inserted. Battery bank 300A can have the same functional configuration as that of battery bank 300. As illustrated, battery bank 300A is secured into a charging cavity 270A while another charging cavity 270 has no battery bank being inserted. When the battery bank 300A is secured in the charging cavity 270A, battery bank 300A itself is in a storage mode. A color coded ring, band, or label can be applied to battery banks 300, 300A to distinguish them from each other.

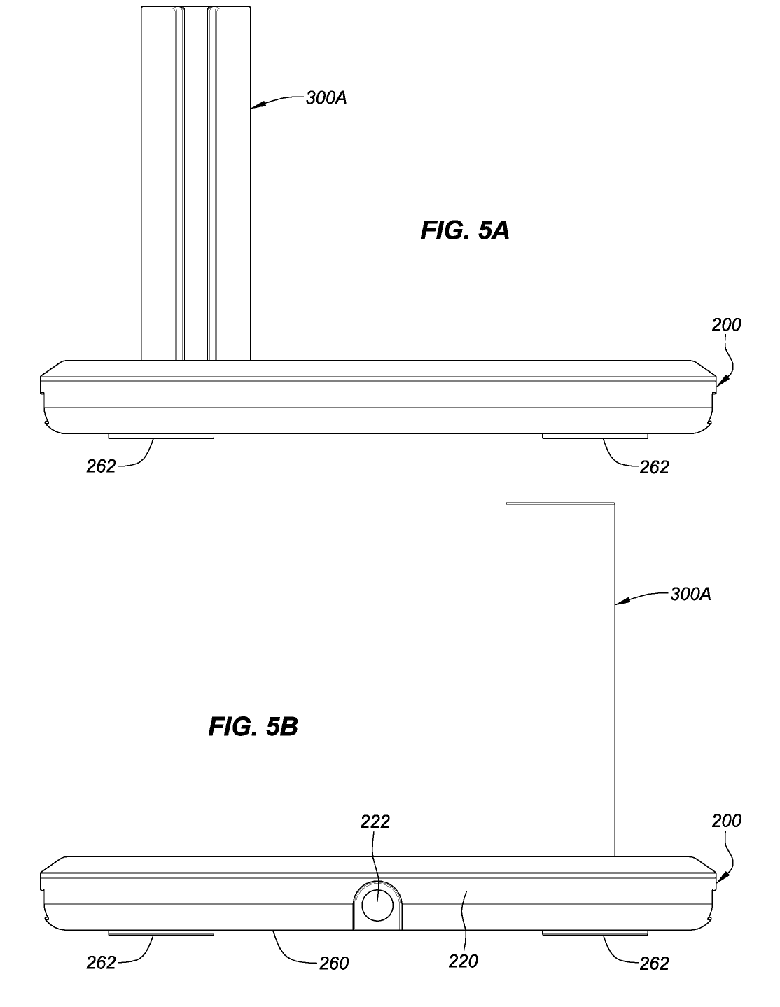

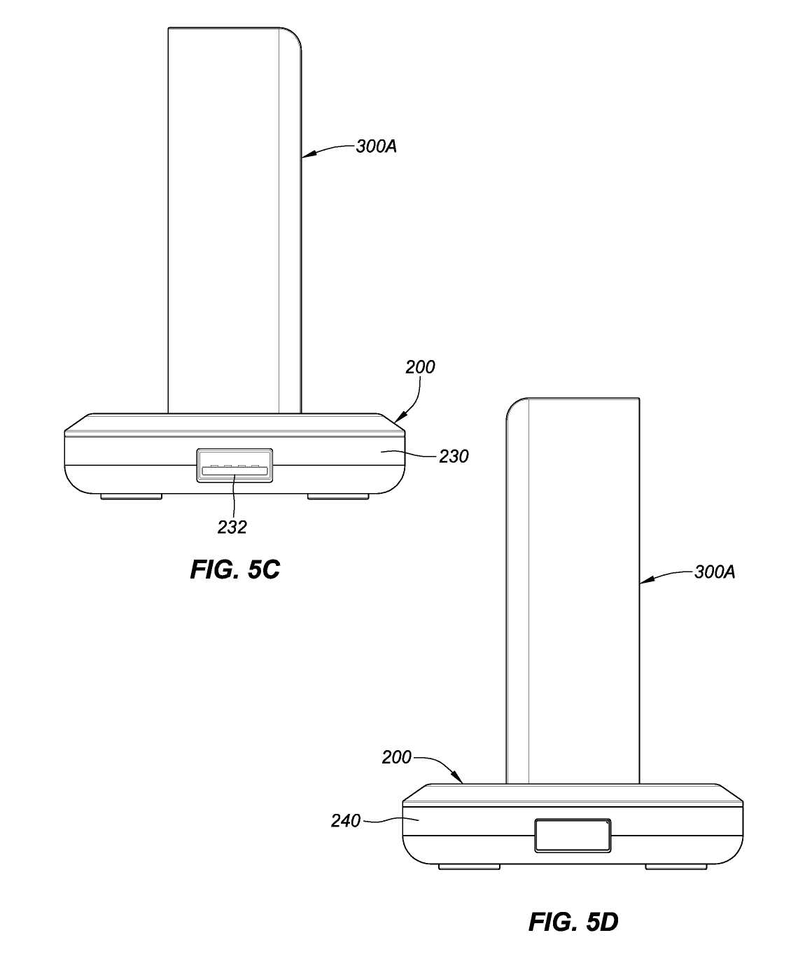

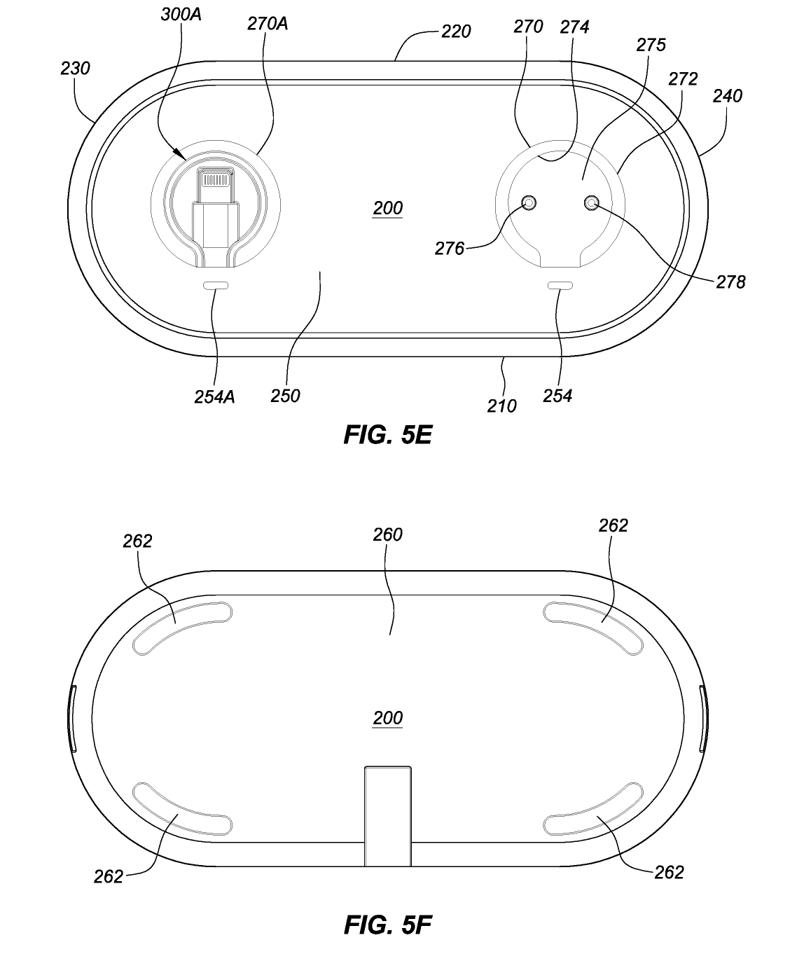

FIGS. 5A-5F are front, rear, left, right, top and bottom views of the charging dock 200 and battery bank 300A of FIGS. 3 and 4. The charging dock 200 has a front side 210, rear side 220, left side 230, right side 240, top side 250 and bottom side 260. The left side 230 and right side 240 are curved. It is understood that the left side 230 and right side 240 can take straight or other shapes. A height of the charging dock 200 is defined by the distance between the top side 250 and bottom side 260.

The top side 250 has charging cavities 270, 270A that are configured to secure battery banks in charging position. As shown, the crater-shaped charging cavity 270 is configured to have an upper portion 272 and a lower portion 274. The upper portion 272 may have a wider upper rim 271 and a narrower lower rim 273 to provide easy access or removal to the battery bank 300. The lower portion 274 is sized to receive the bottom portion of the battery bank 300. The diameter of the lower portion 274 can be the same as the diameter of the lower rim 273.

It is desirable that the charging dock 200 be thin in height to make it light-weighted, portable, or ease to carry around. However, when the charging dock 200 is thin in height, charging cavities 270, 270A may not have enough supporting space to hold the battery banks that are in charging position. The supporting space can be defined by the depth D between the lower rim 273 of the outer ring portion 272 and the bottom side 275 of the charging cavity 270.

As better shown in FIGS. 4 and 5E, charging cavity 270 is configured to have two charging contact pins 276, 278 that can be plugged into charging contacts 356, 358 on the bottom side 350 of battery bank 300 to supply power to the battery bank 300 when it is secured in the charging position. This configuration of two charging contact pins 276, 278 can provide further stability to battery bank 300 when it is secured in the shallow charging cavity 270.

Alternatively, the charging contact pins may be provided on the side wall 279 of the lower portion 274. In this configuration, the charging contacts may be provided on corresponding positions of the battery bank 300.

Indicators 254, 254A can be provided to show the charging level or status on charging cavities 270, 270A. The indicators 254, 254A can be LEDs in any color as desired.

As better shown in FIG. 5B, rear side 220 can have a power input 222 to connect the charging dock 200 to a power source that is configured to supply power to the charging dock 200.

As better shown in FIG. 5C, left side 230 of the charging dock 200 can be provided with a USB port 232 that is configured to provide power to other electronic devices.

As better shown in FIG. 5F, bottom side 260 of the charging dock 200 can be provided with a plurality of feet 262 that are configured to be capable of providing additional elevation to the charging dock 200 and may also be formed with materials that assist in dampening vibrations.

As illustrated in FIG. 2, which shows the unwrapping of the charging cable 320 around the housing 310 and the corresponding position of the charging connector 328 and connector housing 326. When the cable 320 is unwrapped around the cable connection point 322, the charging connector 328 hangs more freely and the battery bank 300 is in a flexible or free-floating cable mode. In this flexible or free-floating cable mode, the cable 320 is extended out from the housing 310 of the battery bank 300 to allow charging a load (e.g., cell phone, tablet, computer, MP3 player, iPad, gaming device, etc.) as illustrated in FIG. 1. This cable 320 provides convenience to the user so that the user does not need to carry extra charging cable.

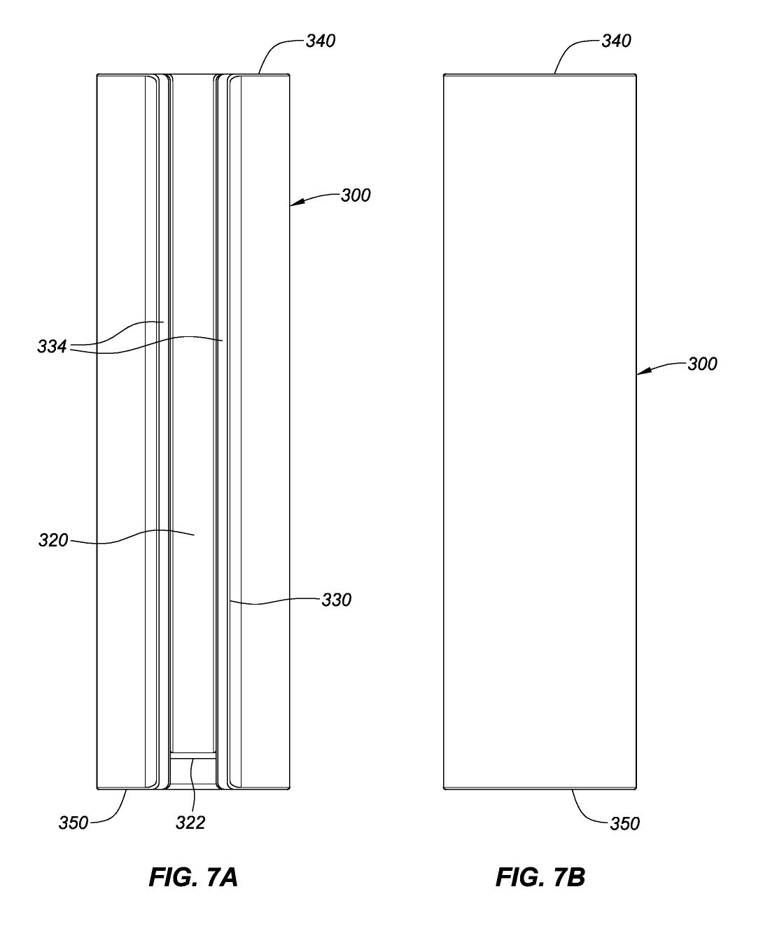

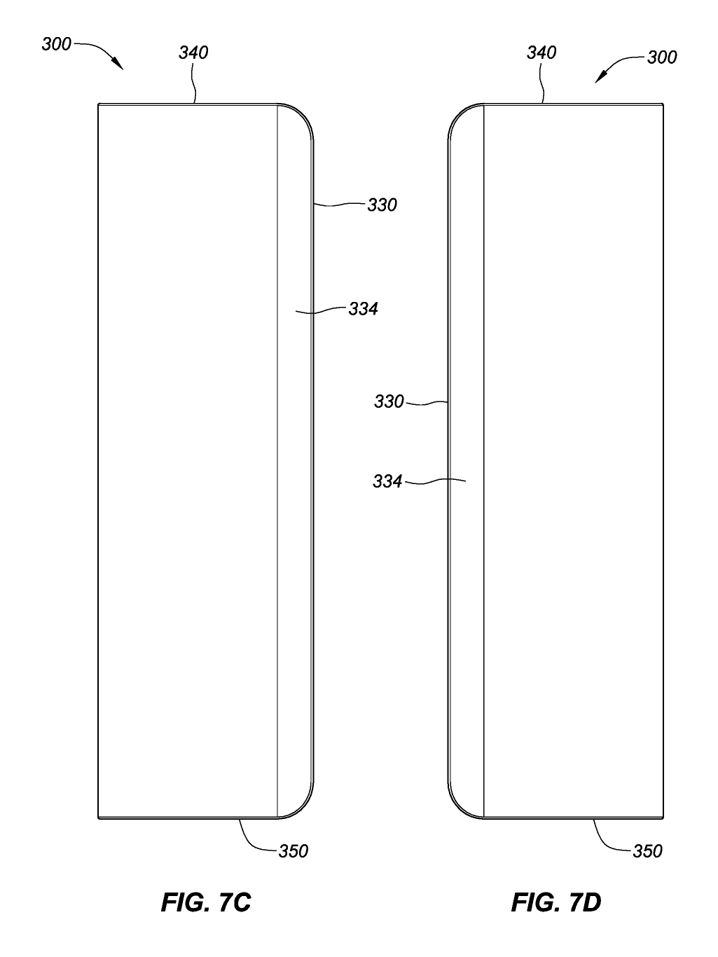

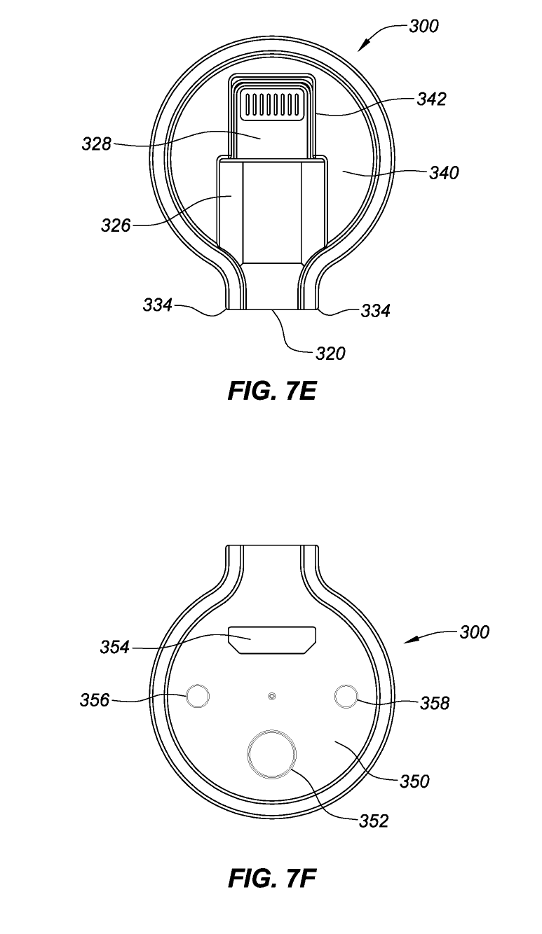

When the charging cable 320 is fully wrapped around the housing 310 as shown in FIG. 6, the battery bank 300 can be put into, or configured into, a storage mode. FIGS. 7A-7F are front, rear, left, right, top and bottom views of the battery bank in storage mode of FIG. 6. In the storage position, the housing 326 of the connector 328 can be tucked into a retention or storage cavity 342 that is formed on the top side 340 of the housing 310. The retention cavity 342 is dimensioned such that the charging connector 328 and connector housing 326 are exposed on either end to facilitate the user's insertion and removal of the charging connector 328 and connector housing 326 from the storage cavity 342. A notch can be included in the storage cavity 342 to allow the user more ready access to the connector housing 326 to ease removal and insertion into the storage cavity 342.

The housing 310 includes a groove 332 (better shown in FIG. 2) that is formed around the front side 330 into the top side 340 of the housing 310. The groove 332 is defined by a recessed region between wall structures 334 protruding on the front side 330. The groove 332 is dimensioned to receive the cable portion 324 when the charging cable 320 is wrapped around the perimeter of the front side of housing 310 in the storage position.

This storage mode conveniently provides a small/compact and portable configuration of the battery bank 300 with built-in cable 320 that is, among other things, user and travel-friendly.

Although various aspects and implementations are herein disclosed in the context of certain preferred embodiments, implementations, and examples, it will be understood by those skilled in the art that the present invention extends beyond the specifically disclosed embodiments to other alternative embodiments and/or uses of the inventive aspects and obvious modifications and equivalents thereof. In addition, while a number of variations of the aspects have been noted, other modifications, which are within their scope, will be readily apparent to those of skill in the art based upon this disclosure. It should be also understood that the scope this disclosure includes the various combinations or sub-combinations of the specific features and aspects of the embodiments disclosed herein, such that the various features, modes of implementation and operation, and aspects of the disclosed subject matter may be combined with or substituted for one another. Thus, it is intended that the scope of the present invention herein disclosed should not be limited by the particular disclosed embodiments or implementations described above, but should be determined only by a fair reading of the claims.

Similarly, this method of disclosure, is not to be interpreted as reflecting an intention that any claim require more features than are expressly recited in that claim. Rather, as the following claims reflect, inventive aspects lie in a combination of fewer than all features of any single foregoing disclosed embodiment. Thus, the claims following the Detailed Description are hereby expressly incorporated into this Detailed Description, with each claim standing on its own as a separate embodiment.

What is claimed is:

1. A portable charging system for a portable mobile device, the charging system comprising:
a charging dock having a top surface, an opposing bottom surface, and sidewalls extending between said top and bottom surfaces, at least one charging cavity opened from the top surface, at least two charging pins provided at the bottom side of the charging cavity; and
at least one battery bank configured to removably plug into the at least one charging cavity, the battery bank having at least two charging contacts on the bottom side of the battery bank that when the battery bank is secured into the charging cavity, the charging pins of the charging dock can plug into the charging contacts of the battery bank to supply power to the battery bank while providing further stability to the battery bank that is in charging position.

2. The portable charging system of claim 1, wherein the at least one battery bank has a cable that is configured to wrap around a side of the battery bank to form a storage mode and to unwrap to form a free-floating cable mode.

3. The portable charging system of claim 2, wherein the battery bank is in the storage mode while being secured in the at least one charging cavity.

4. A portable charging system for a portable mobile device, the charging system comprising:
a charging dock having a top surface, an opposing bottom surface, at least two sidewalls extending between said top and bottom surfaces, a first charging cavity opened from the top surface having a bottom side, and at least two first charging pins provided at the bottom side of the first charging cavity; and
a first battery bank having a cylindrical housing configured to removably plug into the first charging cavity, the housing having a top side, a bottom side, and a side wall extending between said top and bottom sides, the first battery bank having at least two first charging contacts positioned on the bottom side of the first battery bank;
wherein when the first battery bank is secured in the first charging cavity, the first charging pins can plug into the first charging contacts of the first battery bank to supply power to the first battery bank while providing further stability to the first battery bank that is in charging position.

5. The portable charging system of claim 4, wherein the first battery bank has a cable configured to wrap around the side wall of the first battery bank to form a storage mode and to unwrap around a cable connection point to form a free-floating cable mode.

6. The portable charging system of claim 5, wherein when the first battery bank is in the free-floating cable mode, the cable is extended out from the housing of the first battery bank to allow charging a load.

7. The portable charging system of claim 5, wherein the first battery bank is in the storage mode while being secured in the first charging cavity.

8. The portable charging system of claim 5, wherein the cable is concealed within a groove formed into the side wall of the housing in the storage mode.

9. The portable charging system of claim 8, wherein the cable has a charging connector configured to be tucked into a retention formed on the top side of the housing.

10. The portable charging system of claim 4, wherein the housing of the first battery bank contains at least one rechargeable battery.

11. The portable charging system of claim 10, wherein the first battery bank has a removable cap to allow the at least one rechargeable battery to be removed or replaced by the user.

12. The portable charging system of claim 10, wherein the first battery bank is permanently sealed to preclude the removal or replacement of the at least one rechargeable battery.

13. The portable charging system of claim 4, further comprising a second charging cavity opened from the top surface of the charging dock having a bottom side, wherein at least two second charging pins are provided at the bottom side of the second charging cavity.

14. The portable charging system of claim 13, further comprising a second battery bank configured to removably plug into the first or second charging cavity, the second battery bank comprising a second top side, a second bottom side, a second side wall extending between said second top and bottom sides, and at least two second charging contacts positioned on the second bottom side of the second battery bank, wherein when the second battery bank is secured into the first or second charging cavity, the first or second charging pins can plug into the second charging contacts of the second battery bank to supply power to the second battery bank while providing further stability to the second battery bank under charging.

15. The portable charging system of claim 14, wherein the first battery bank is also configured to removably plug into the second charging cavity of the charging dock.

16. The portable charging system of claim 14, further comprising a third charging cavity opened from the top surface of the charging dock having a bottom side, and at least two third charging pins provided at the bottom side of the third charging cavity.

17. The portable charging system of claim 14, wherein a color coded ring, band, or label is applied to the first and second battery banks to distinguish them from each other.

18. The portable charging system of claim 14, further comprising first and second indicators to show the charging status on the first and second charging cavities, respectively.
